(19) United States
(12) Patent Application Publication
(10) Pub. No.: US 2005/0050122 A1
(43) Pub. Date: Mar. 3, 2005

(54) Object-oriented pseudo-random number generator interface

(76) Inventors: Andreas Blumenthal, Heidelberg (DE); Peter Januschke, Karlsruhe (DE); Udo Klein, Maximlliansau (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/741,749

(22) Filed: Dec. 18, 2003

Related U.S. Application Data
(63) Continuation-in-part of application No. 10/653,789, filed on Sep. 2, 2003.

(51) Int. Cl. G06F 1/02

(52) U.S. Cl. 708/250

(57) ABSTRACT

Systems and techniques to generate pseudo-random numbers in a specified target range. In general, in one implementation, the technique includes an object class definition that defines a constructor method for generating a pseudo-random number generator object that is capable of generating pseudo-random numbers within a specified output range and a method for instructing the pseudo-random number generator object to output a pseudo-random numbers within the specified output range. The pseudo-random number generator may use a specified seed. In that case, generating pseudo-random numbers within a specified output range may generate a reproducible sequence if the same seed is used. The pseudo-random number generator may be defined to generate pseudo-random numbers that are uniformly distributed across the specified output range.

### CROSS REFERENCE TO RELATED APPLICATIONS

This application is a continuation-in-part and claims the benefit under 35 U.S.C. 120 of U.S. Ser. No. 10/653,789, filed Sep. 2, 2003, entitled, “Mapping Pseudo-Random Numbers to Predefined Number Ranges.”

### BACKGROUND

The following description relates to interfaces for generating pseudo-random numbers (“PRNs”), particularly, interfaces for generating PRNs in a predefined range.

Pseudo-random number generators (“PRNGs”) are an important part of modern computing, finding use in various applications including generating test data and random sampling for quality assurance, statistical simulations, generative modeling, cryptography and the Monte Carlo method for simulating physical systems. The capability to generate PRNs typically is a standard feature of most software programming environments.

Generating PRNs usually is implemented by one or more algorithms that generate a series of uncorrelated numbers, with each succeeding random number using the previous result as its seed. Thus, by knowing what the original seed is, along with the algorithm used, the same sequence of numbers can be re-generated in a predictable manner, i.e. reproducible. The PRNs are considered pseudo-random, as opposed to truly random, because, even though they are deterministic based on the seed and algorithm used, the sequence of PRNs is relatively uncorrelated and appears random for most statistical tests. To that end, most PRNG algorithms produce numbers that tend to be uniformly distributed across a fixed range of numbers, for example, between 0 and 2³¹−1.

Common categories of PRNGs include linear congruential generators, lagged fibonacci generators, linear feedback shift registers and generalised feedback registers. More recent examples of PRNGs include Blum Blum Shub, Fortuna, and the Mersenne Twister. Generally, these PRNGs tend to have functional interfaces, i.e., an “initialized” procedure and some form of a “get_random_number” function. Also, these PRNGs tend to generate PRNs in a range 0, . . . 2^{b}−1, where b is the bit length of a b-bit PRNG. The generated output range does not necessarily match what is desired or needed for some applications, such as picking random samples from a given range (e.g., picking 10 out of 1000 delivered goods for quality testing), which would require the PRNs in a range 1, . . . 1000. To generate the desired range, a range mapping may be performed, which can map the generated numbers from the range 0, . . . 2^{b}−1 to the desired range.

### SUMMARY

The object-oriented interface described here, and corresponding techniques for use, may include various combinations of the following features.

A method that facilitates the generation of pseudo-random numbers may include receiving an input specifying an output range and invoking a constructor method to generate a pseudo-random number generator object having one or more methods for generating pseudo-random numbers within the specified output range.

Implementations may include one or more of the following features. The generated pseudo-random number generator object may be configured to generate pseudo-random numbers that are uniformly distributed across the specified output range. A method within the pseudo-random number generator object for outputting a pseudo-random number within the specified output range may be invoked. Input may be received that specifies a seed to be used by the pseudo-random number generator object to generate pseudo-random numbers. In that case, a sequence of pseudo-random numbers generated within the specified output range may be reproducible if the input specifies the same seed. A method within the generated pseudo-random number generator object for generating a seed may be invoked. A method for generating pseudo-random numbers uniformly distributed across the specified output range may include generating pseudo-random numbers that have a uniform distribution in a source range, selecting an optimal subset of the pseudo-random numbers to map, and mapping the selected pseudo-random numbers to a corresponding number in the specified output range such that the mapped numbers are uniformly distributed across the specified output range. The pseudo-random number generator object may be serializable. The constructor method may generate pseudo-random numbers that have a uniform distribution in a source range, select an optimal subset of the pseudo-random numbers to map, and map the selected pseudo-random numbers to a corresponding number in the specified output range such that the mapped numbers are uniformly distributed across the specified output range. A method for generating pseudo-random numbers within the specified output range may generate numbers of a single data type.

In another aspect, a method facilitates the generation of a pseudo-random number generator. In that case, the method includes providing a class definition that defines an object for generating pseudo-random numbers within a specified output range, receiving input specifying the output range, and invoking a constructor method to create a pseudo-random number generator object capable of providing pseudo-random numbers in the specified output range.

Implementations may include one or more of the following features. An instruction to return a pseudo-random number within the specified output range may be received. In that case, a next pseudo-random number within the specified output range may be generated.

In another aspect, a method of generating pseudo-random numbers, includes providing an output range to a pseudo-random number generator object and invoking a method within the pseudo-random number generator object that causes pseudo-random numbers within the output range to be generated by the pseudo-random number generator object.

Implementations may include one or more of the following features. A method may be invoked to generate a pseudo-random number generator object that can generate pseudo-random numbers within a specified output range. The output range may be predefined. A seed may be provided to a pseudo-random number generator object. In that case, the seed may be predefined.

In another aspect, a method that facilitates the generation of PRNs includes providing a single object-oriented interface that enables PRN generation and PRN mapping. In that case, the single object-oriented interface includes a constructor method for generating a PRNG object that is capable of generating PRNs within a specified output range, and a method for instructing the PRNG object to output PRNs within the specified output range.

These general and specific aspects may be implemented using a system, a method, a computer program, or an object-oriented class definition, or any combination of systems, methods, computer programs, and object-oriented class definitions.

The object-oriented interface described here may provide one or more of the following advantages. The object-oriented interface may be in the form of a class, known as a pseudo-random number generator (“PRNG”) class, which may combine pseudo-random number (PRN) generation and pseudo-random number (“PRN”) mapping. The PRNG class may generate a PRNG object. The PRNG object may generate PRNs within a specified output range. The specified output range may be predetermined for data types where a certain output range is used for all practical applications, thus benefiting users who do not wish to input an output range every time they use the PRNG object. In addition, the PRNs may be uniformly distributed across the specified output range. The PRNG object may increase efficient use of computing resources because the PRNG object may pre-compute PRN generation and mapping, rather than having to do so each time a PRN is desired. The PRNG object may use a specified seed to generate PRNs. The PRNG object may provide a sequence of PRNs that is reproducible if the same seed is specified, which may be desirable for quality assurance and testing environments that may require reproducible results. The object-oriented interface class may provide a single interface for PRN generation and PRN mapping, thereby freeing programmers from the tasks of either PRN generation or PRN mapping. The single interface may reduce errors and time spent debugging because all parts of PRN generation and PRN mapping may be consolidated in one interface rather than spread across multiple programs, functions, and/or objects.

Details of one or more implementations are set forth in the accompanying drawings and the description below. Other features and advantages may be apparent from the description and drawings, and from the claims.

### BRIEF DESCRIPTION OF THE DRAWINGS

These and other aspects will now be described in detail with reference to the following drawings.

FIG. 1 is a block diagram of a PRNG class.

FIG. 2 is a diagram illustrating the use of a PRNG class.

FIG. 3 is an illustration of a technique to map the output range of a PRNG to a smaller desired output range.

FIG. 4 is a flow chart depicting a process for mapping the output range of a PRNG to a smaller desired output range.

FIG. 5 is an illustration of a technique to generate and map packed numbers to a desired output range.

FIG. 6 is a flow chart depicting a process for generating packed numbers.

FIG. 7 is a flow chart depicting a process for mapping packed numbers to a desired output range.

FIG. 8 is a block diagram of a computer system that may be used to implement the PRNG systems and techniques described here.

Like reference numerals and designations in the drawings indicate like elements.

### DETAILED DESCRIPTION

The systems and techniques described here relate to the design of an object-oriented pseudo-random number generator (“PRNG”).

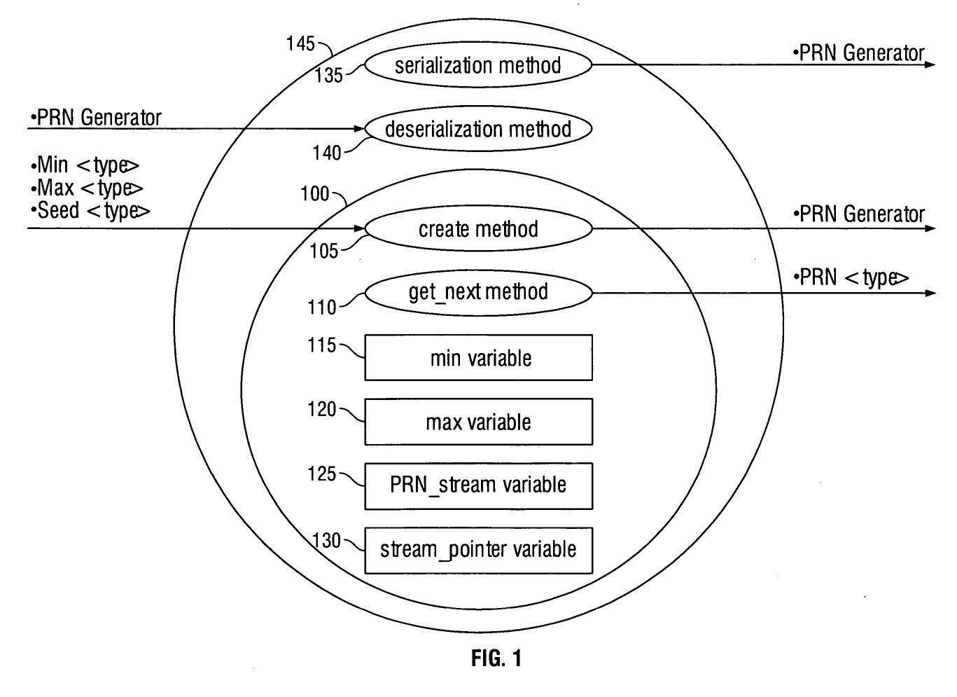

FIG. 1 is a block diagram of an object-oriented PRNG class 100. A class defines the members of an object. Objects are reusable software components. Each object is an instance of a class. Members of a class may include methods, variables, and references. Methods, also known as procedures, functions, and the like, include a series of statements that are compiled and/or executed by a processor and/or virtual machine. Methods may generate a return value, also known as output. Methods can use mechanisms and techniques other than return values to produce output, including mechanisms that cause information to be written to a file, displayed on a display device, or sent over a network. Methods are invoked by a function call. A function call specifies the method name and may provide arguments that a called method can manipulate. Constructors are a special type of method that initializes an object and/or generates an instance of an object. Variables, also known as parameters, attributes, and the like, can be assigned a value. Variables may be constant, such that the assigned value need not change during the execution of a program, or dynamic, such that the assigned value may change during the execution of a program. Variables can be of any data type, including character, integer, float, packed integer, and user-defined class. Variables can also be in the form of a reference-type variable, known as a pointer. A reference need not be a variable, and can be used to reference a variable.

The PRNG class 100 defines a PRNG object (not shown). The PRNG class 100 and/or PRNG object may provide a convenient interface for generating pseudo-random numbers within a specified output range. The PRNG class 100 may encapsulate methods, 105-110, and variables, 115-130. In addition, the PRNG class 100 may be serializable, such that the state of a PRNG object may be copied or generated from a copy.

The PRNG class 100 is defined to include a create method 105, which generates a PRNG object, and a get_next method 110, which generates a PRN that is within a specified output range. Optionally, in special instances, the PRNG class 100 may include a method for generating a seed value, such as a seed method. The create method 110 may be a constructor that generates an instance of the PRNG interface. The constructor generates an instance of the PRNG object by returning a PRNG object, by initializing an already existing PRNG object, and/or by any other technique. The create method 105 may take arguments specifying a seed and specifying an output range. Alternatively, the create method 105 may be a method other than a constructor. In alternative implementations, the create method 105 need not take arguments or may take any number of arguments. Also, a PRNG object may have a predefined output range for PRN mapping. For example, a PRNG object that generates PRNs of the data type float may be predefined to generate numbers only in the range of [0, 1), i.e. zero to one, including zero and excluding the number one.

The create method 105 may be defined to generate PRNs within the specified output range. Generation of PRNs within the specified output range may be defined as a three-part process. In that case, the first part includes generating the PRNs, the second part includes selecting a subset of the PRNs to map, and the third part includes mapping the selected PRNs within a specified output range. The selected PRNs may be mapped such that they are uniformly distributed across the specified output range. Alternatively, the create method 105 need not be defined to perform all or part of generating PRNs within the specified output range. For example, other methods, such as the get_next method, may perform a portion of PRN generation. Also, in alternative implementations, the generation of PRNs within the specified output range may be defined as requiring any number of processes, defined across any number of methods, in any order.

The create method 105 may be defined to take an argument specifying a seed value. The seed value may be used for PRN generation. A seed value may be used so that reproducible sequences of PRNs may be advantageously generated. Sequences of PRNs may be reproducible if the same seed is specified each time PRNs are generated within the specified output range. A reproducible sequence may be advantageous, for example, for purposes of quality assurance and testing where reproducible PRNs may be desirable to reproduce test results. In alternative implementations the seed value need not be an argument to the create method 105 and may be specified as an argument to another method. For example, a method may be defined that requests user input for a seed value. Alternatively, the seed value need not be an argument to a method, and may be specified by other means. For example, the seed value may be specified in a file, specified by user input, and/or specified by a predefined value. Alternative techniques may be used to generate reproducible. For example, a PRNG object may be defined to store generated PRNs and store a pointer. The pointer may go across the sequence of PRNs and the PRNG object may output PRNs based on the pointer's location. A reproducible sequence may be generated if the pointer is set to the start of the sequence, where the PRNG object may have originally outputted a sequence.

The create method 105 may be defined to take any number of arguments that specify the output range. For example, the argument or arguments specifying the output range may include a variable for the minimum and a variable for the maximum. The data type of the specified output range may be similar to the data type of PRNs generated within the specified output range. If the minimum value is greater than the maximum value, an error, such as an exception, may be generated and returned to a user indicating that an improper range was specified. The arguments for the minimum and the maximum may be stored in the PRNG object for later user in PRN mapping. Alternative techniques may be used to specify the output range. For example, an array of integers, which may be specified by a single argument, may be used to specify the output range. In alternative implementations, the output range values need not be arguments to the create method, but rather may be specified by arguments to another method. Also, in alternative implementations, the output range need not be arguments to a method, and may be specified by other means. For example, the output range may be specified in a file, specified by user input, and/or specified by a predefined value. Also, alternatively, the specified output range need not be stored in the PRNG object.

The create method 105 may be defined to output a PRNG object, or a reference pointer to a PRNG object. For example, a program may include the following code (numbering indicates line numbers):
1. PRNG PRNG1;
2. PRNG1=PRNG->create( );.

In the object-oriented program code used above, the first line declares a variable PRNG1 of the PRNG interface data type. The second line of code calls the create method 105 of the PRNG class 100, and returns a PRNG object, which is assigned the variable PRNG1. Alternatively, the create method 105 need not have output. For example, the create method 105 may be a constructor method in an object-oriented programming language environment where constructor methods generate an object without using return values. In such a programming environment, the create method 105 may be called and a PRNG object may be generated without the create method 105 generating output.

The PRNG class 100 may be defined to include a method for outputting a PRN within the specified output range, such as get_next 110. The get_next method 110 may be involved in the generation of PRNs within the specified output range, or the get_next method 110 may take numbers from a data type stored in an instance of the PRNG object, where PRNs may already be within the specified output range. The PRNs that are generated may be of any data type that may be suitable for pseudo-random number generation, including fixed-length data types (such as integer, packed integer, float, long, double), variable-length data types (for which the length of the data type may change), multidimensional data types (for which different data types may be exist within a single multidimensional object), and user-defined data types, such as a class or structure.

A PRNG object may be configured to output PRNs of a single data type, or may be configured to generate PRNs of different data types. If a PRNG object is configured to output different PRN data types, the get_next method 110 could output a different data type depending on variants of the PRNG class 100. For example, two PRN interface classes may exist that define two PRNG objects, named PRNG_float, and PRNG_int, respectively, which may be very similar, except that PRNG_float may generate PRNs of a float data type, and PRNG_int may generate PRNs of an integer data type. The get_next method 110 of PRNG_float may output PRNs of the type float and the get_next method 110 of the PRNG_int may output PRNs of the type integer. In alternative implementations a single PRNG class 100 may have various methods that are defined to each output a PRN of a certain data type within a specified output range. For example, a PRNG class 100 may be defined to include a method for outputting PRNs of the data type float, such as get_next_float, and a method for outputting PRNs of the data type integer, such as get_next_int. Alternatively, a PRNG object may generate PRNs of different data types by having a single method, such as get_next, that outputs a multidimensional object, which stores different data types. In addition, alternative techniques may be used to generate different types of PRNs. Also, although a PRNG object may output a single PRN each time a method, such as get_next 110, is invoked, alternative implementations of the PRNG object may output any number of PRNs, including all the PRNs which are within the specified output range. Although a PRNG object may output the PRNs as data objects, the PRNG object may cause the PRNs to be outputted through other mechanisms and techniques, including displaying output on a display device and/or printing output through a printer.

Optionally, the PRNG class 100 may be defined to include a method for generating and outputting a random seed for use in PRN generation, such as a seed method. The seed method need not have arguments when called. The seed method may exist only in certain implementations of the PRNG. For example, the seed method may exist in a PRNG depending on the data type of PRNs that are generated, such that the seed method may only exist in a PRNG class that generates PRNs of a multidimensional data type. The generated random seed may be of an integer data type. For example, a PRNG that may generate PRNs of a multidimensional data type may generate a random seed of an integer data type. Also, the seed may be later used for PRN generation. For example, a seed method of a PRNG object may return an integer data type random seed. The random seed may then be used to call a PRNG object to generate PRNs within the specified output range. In alternative implementations, the seed method may generate a random seed and need not output the random seed. For example, a PRNG object may generate a random seed and store the random seed in the PRNG object.

The PRNG class 100 may be defined to include a set of variables for specifying the output range, such as min 115 and max 120; a variable for storing a stream of PRNs within the specified output range, such as PRN_stream 125; and, a variable that acts as a pointer to a location in a stream of PRNs, such as stream_pointer 130. The variables that may specify the output range, min 115 and max 120, may be stored in an instance of the PRNG object. The values of the variables may originate from any number of sources, including arguments to a method, user input, and/or predefined values. For example, the create method 105 may initialize a PRNG object and take an argument that specifies the output range. The create method 105 may store the values associated with that argument in the PRNG object. Alternatively, a user may be prompted to specify the output range through a user interface. In another alternative implementation, values such as 200 and 300 may be predefined in the PRNG class 100 as the minimum and maximum of the specified output range.

The PRNG class 100 may include a variable for storing a stream of PRNs within the specified output range, PRN_stream 125. After PRNs are generated and mapped within the specified output range, the mapped PRNs may be stored so that they can be output one at a time by a method such as get_next 110. Alternatively, the PRNs need not be stored, and the PRNs may be generated in response to each call of a method, such as the method get_next 110. The variable for storing the PRNs may be any data type, including data types corresponding to the data type of the PRNs, or a different data type, such as a linked list of PRNs, where each element of the list stores a separate PRN.

The PRNG class 100 may include a variable that indicates a location in the sequence of PRNs that may be outputted. For example, the variable may be a pointer, such as stream_pointer 130. The pointer may reference a location, such as a location in an array of PRNs. The pointer may advance to the next PRN in a sequence in response to the PRNG object outputting a PRN. Alternatively, the variable need not be a pointer, as the term is used in programming languages, and may be a value that represents a location in a stream of PRNs by other techniques or mechanisms. For example, a counter may be used. The counter may be incremented each time a PRN may be outputted, thus indicating a location along a stream of PRNs.

The PRNG class 100 may be implemented using mechanisms and techniques that allow for the state of a PRNG object to be copied or generated. In an object-oriented programming language this may include making the PRNG class 100 serializable. A serializable class may include a method for serialization 135 and/or deserialization 140. Serialization may allow for a serialized PRNG object to be generated. Deserialization may generate a PRNG object from a serialized PRNG object, such that the generated PRNG object has a state similar to the state of the PRNG object corresponding to the serialized PRNG object. A serialized object may be a copy of the state of the PRNG object which may be read and/or written from an input and/or output stream (collectively I/O streams), respectively. The I/O streams may operate to allow a read and/or write of a PRNG serialized object to a file on a storage device, on another computer via a network, or otherwise. For example, the PRNG class 100 may be defined in an object-oriented programming language that includes data constructs known as interfaces, and the PRNG class 100 may be defined to implement an interface that includes methods for serialization and deserialization, such as serialization interface 145. To make a copy of the state of a PRNG object and write it to a file, the object's serialization method 135 may be called to generated a serialized object, the serialized PRNG object may be written to an output stream, and the output stream may be written to a file. Other techniques may be used to copy the state of a PRNG object, including a copy constructor, an overloaded assignment operator, and/or overloaded input/output stream operators.

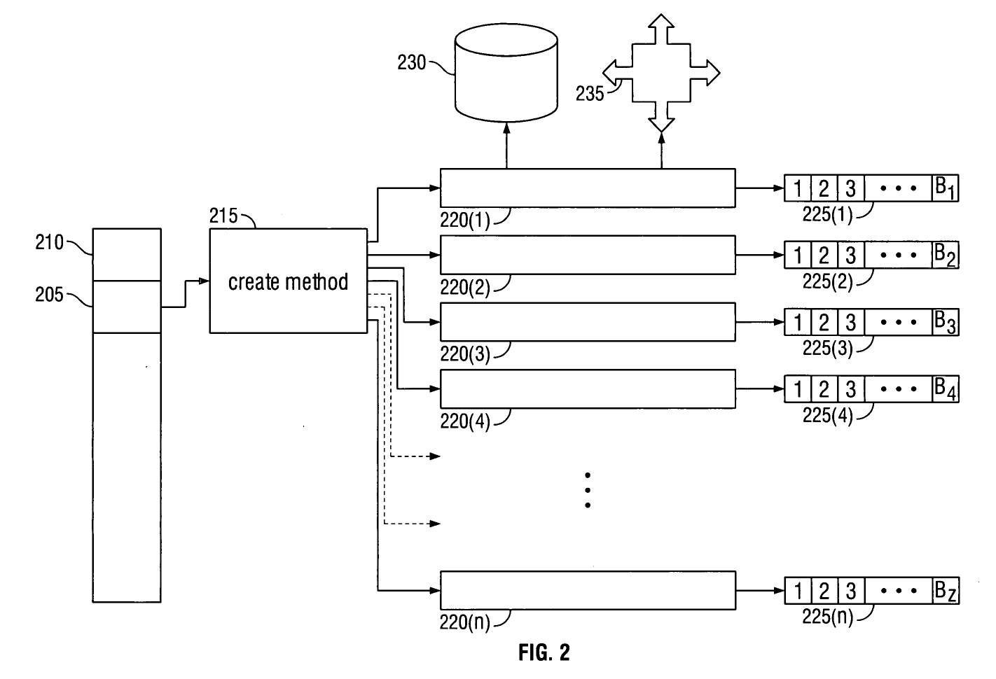

FIG. 2 is a diagram illustrating how a PRNG class may be used to generate PRNs within a specified output range.

A program 205 may reside in a memory 210. The program may call a method, such as create 215, which may be in the memory 210. The method create may be a constructor method, which may be defined as a member of a PRNG class. The PRNG class that defines 215 may be compiled as part of the program 205. In response to the call of the create method 215, any number of PRNG objects, such as PRNG objects 220(1)-(n) (collectively PRNG objects 220), may be initialized and/or generated. Alternatively, the program 205 and/or the method 215 may be resident on an other device of a computer system. In alternative implementations the method create 215 need not be a constructor method and may be any method that may be defined to be a member of a PRNG class that may generate and/or initialize a PRNG object. Further, in alternative implementations, the method create 215 need not be defined to initialize and/or generate a PRNG object, and the method may merely be a method stub that calls other methods, programs, and the like, which initialize and/or generate a PRNG object.

Each PRNG object may be defined to generate and map PRNs within a specified output range. Any number of techniques and/or mechanisms may be used to specify an output range, including user input and/or a predefined value.

Generation of PRNs may require the use of a specified seed value. A seed may be specified by various techniques and/or mechanisms, including user input, a predefined value, and/or a pseudo-randomly generated seed. Each of the PRNG objects 220 may use a different seed so that independent streams of PRNs may be generated and mapped within the specified output range. The PRNs that are generated and mapped may be stored in the PRNG objects 220. The sequences of the PRNs generated by the PRNG objects 220 may be reproducible if the same seed value is given. For example, if PRNG objects 220(1) and 220(2) generate PRNs of type integer, and the PRNG objects 220(1) and 220(2) each generate PRNs with the same specified seed value, such as 5, and output range, such as 0 to 15, the sequence of PRNs outputted from both 220(1) and 215(2) may be identical. Alternatively, the PRNs need not be stored in the PRNG objects 220. In alternative implementations the sequence of PRNs may any degree of reproducibility. For example, the sequence of PRNs may be similar only for ten values spread across a mapping of PRNs. Also, in alternative implementations the sequence of PRNs need not be reproducible.

The PRNG objects 220 may be defined to include a method that allows each PRNG object to output a stream of PRNs, such that each of the PRNG objects 220(1)-(n) may output a stream of PRNs 225(1)-(n), respectively. Any number of PRNs may be outputted in response to a function call of a method defined to output PRNs, including one PRN at a time, a couple PRNs, or all PRNs within the specified output range.

The PRNs may be outputted as a sequence, which may be tracked by a pointer or other mechanisms and/or techniques, which may be stored in the PRNG objects 220. The pointer may advance down the sequence of PRNs that are generated within the specified output range, and output a single PRN in response to a function call of a method defined to output a PRN. When the pointer has reached the end of the sequence, any number of techniques and/or mechanisms may be used to continue the output of PRNs, including setting the pointer to the beginning of the sequence, or generating a new sequence of PRNs within the specified output range. The newly generated sequence of PRNs may be distinct from the earlier sequence. In alternative implementations the pointer need not be stored in each PRNG object. Also, in alternative implementations, the PRN generator may stop outputting PRNs when the end of the sequence is reached and may give an exception.

The data type of the PRNG objects 220 may vary. For example, PRNG object 220(1) may generate PRNs of the data type float, while PRNG object 220(2) may generate PRNs of the data type integer. In alternative implementations all the PRNG objects 220 may generate PRNs of the same data type. Also, in alternative implementations the data types that a PRNG object may generate may include fixed-length data types, variable-length data types, multidimensional data types, and/or user-defined data types.

PRNG objects 220 may be serializable, such that the state of an object may be written and/or read from an output and/or input stream. A serializable object typically includes a serialization and a deserialization method. Serialization may generate a serialized PRNG object that represents, the state of a PRNG object. Deserialization may generate a PRNG object from a serialized PRNG object, such that the generated PRNG object has a state similar to the state of the PRNG object corresponding to the serialized PRNG object. A serialized object may be in a certain format, such as binary or ASCII text, and in a certain structure, which may represent the state of the PRNG object. For example, the structure of a serialized PRNG object may be a list of all variables in a PRNG object and their corresponding values. Each item in the list may be separated by a semicolon, and the variables may be separated from their corresponding values by a comma. If a PRNG object has a state that includes a variable specifying the minimum of the output range as 10 and a variable specifying the maximum of the output range as 12, the structure of the corresponding serialized PRNG object may appear as: (minimum, 10; maximum, 12). The serialized object may be read and/or written from an input and/or output stream, respectively, which may operate to allow a read and/or write of a PRNG serialized object to a storage device 230, on another computer via a network 235, or otherwise. Reading and/or writing the input and/or output stream to a storage device may include the generating or opening of a file. Reading and/or writing an input and/or output stream via a network may include the transferring or receiving of a file that represents the serialized object. In alternative implementations, PRNG objects 220 may be implemented using other mechanisms and techniques which allow for the state of a PRNG object to be copied or generated, including a copy constructor, an overloaded assignment operator, and/or overloaded input/output stream operators.

The following description of a PRNG involves a particular algorithm for both PRN generation and PRN mapping. Implementations of the object-oriented interface that includes both PRN generation and PRN mapping may be implemented using any combination of PRN generation instead of, or in addition to, the following described implementation.

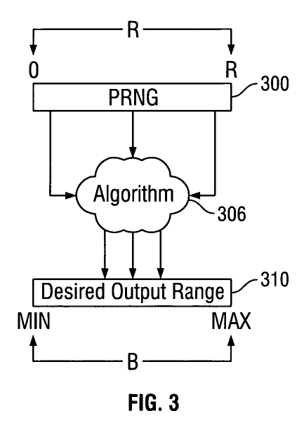

FIG. 3 illustrates, in general, a technique for mapping the range of a b-bit PRNG to an arbitrary smaller desired output range. The technique illustrated in FIG. 3 may be defined in the PRNG class 100. PRNG 300 is a PRNG that does not provide PRNs within a specified output range. A b-bit PRNG typically can generate uniformly distributed b-bit random numbers in a range 0, 1, . . . R, where R is 2^{b}−1. The range of the PRNG may be referred to as a source range. The period of a b-bit PRNG then will be 2^{b}−1. In one implementation, PRNG 300 is a 32-bit PRNG. Thus, PRNG 300 has a period of 2³²−1. What this means is that PRNG 300 can generate 2³²−1 integers in the range 0, 1, . . . R, where R is 2³²−1. In this implementation, the smaller Desired Output Range 310 (i.e. the specified output range) is min, . . . max, with (max−min)≦R. The period of the Desired Output Range 310 is B, which is max−min+1 and is less than the period of PRNG 300. An Algorithm 306, e.g., a mapping function, is used to map the output of PRNG 300 to a smaller Desired Output Range 310. The Algorithm 206 is implemented in C programming language, but other programming languages may be used.

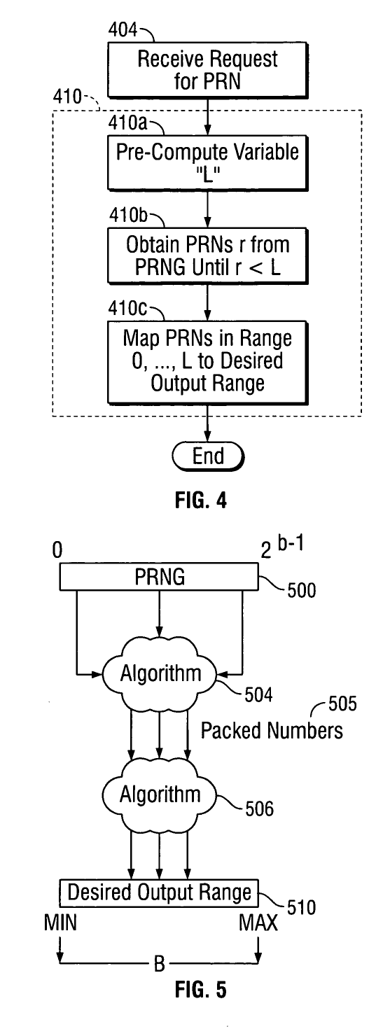

FIG. 4 depicts a process of mapping the output range of a PRNG (e.g., PRNG 300) to a desired output range (e.g., Desired Output Range 310) according to one implementation, e.g., a database application programmed using the Advanced Business Application Programming (“ABAP”) language. In step 404, a PRNG manager receives a request for one ore more PRNs in a desired output range. Next, in step 410, the PRNG manager applies a mapping function to the output range of the PRNG.

In step 410a, the mapping function performs arithmetic computations as follows: L=S*B, where B is max−min+1 and S is (R+1) div B, which is the integer part of (R+1)/B. As can be seen from these arithmetic computations, S≧1 given (max-min)≦R and 0≦(R+1−L)<B. The variable L is an optimal match to the desired output range, which is derived from the size of the output of the PRNG and the size of the desired output range. Next, in step 410b, the mapping function obtains uniformly distributed pseudo-random numbers r from the PRNG until r<L. In step 410c, the mapping function maps those numbers that fall within the range 0, 1, . . . L to the same number of numbers in the desired output range, which are (r div S)+min. As a result, the mapped numbers in the desired output range are uniformly distributed pseudo-random numbers, i.e., the mapping function can maintain the degree of pseudo-randomness of the pseudo random numbers generated by the PRNG. Thus, if the pseudo-randomness of the pseudo random numbers generated by the PRNG is one of uniform distribution, then the pseudo-randomness of the mapped numbers is one of uniform distribution. Optionally, the objective of steps 410b and 410c could be achieved by causing the PRNG to generate uniformly distributed pseudo-random numbers r until r<L.

The following code module, written in C (although any other language suitable to map pseudo-random numbers could be used), generally is suitable to map pseudo-random numbers to a smaller desired output range:

```
static unsigned int prngIntInRange( int min, int max )
{
unsigned int delta0 = max − min;
unsigned int s;
unsigned int prod;
unsigned int r;
unsigned int y;
if ( delta0 == SAP_UINT_MAX )
{
  return prngNextNumber( );
}
s = ( unsigned int ) ( ( ( SAP_ULLONG ) SAP_UINT_MAX + 1 ) /
( delta0 + 1 ) );
prod = s * ( delta0 + 1 );
while ( 1 )
{
  r = prngNextNumber( );
  if ( r < prod )
  break;
}
return ( r / s + min );
}
```

This technique for mapping the output range of a b-bit PRNG to a smaller arbitrary desired output range can be implemented with unsigned long integers. In case min and max are signed integers, the process described above can still be implemented with unsigned long integers, except for computing B (i.e., the size of the desired output range) and the final mapping. This way there is no need for slow extended integer arithmetic, which is possible because the C programming language allows use of both signed and unsigned integer types.

An optional step may be included in the process described above, wherein the number of bits needed to generate mapped uniformly distributed PRNs is minimized. Generally, the probability, P, for discarding a PRN r that is generated by a PRNG is in accordance with the following formula:
P=(R+1−L)/(R+1)<B/(R+1)

Using the geometric series, it can be determined that, in order to produce a PRN that falls within the desired output range, an average of 1/(1−P) PRNs needs to be generated by the PRNG. As can be seen, in cases where B, i.e., the size of the desired output range, is much smaller than R, i.e., the size of the output range of the PRNG, the generation of unnecessary PRNs is minimized.

If the PRNG generates PRNs in the range 0, . . . 2^{b}−1 and min and max are fixed, then the average number of required random bits may be optimized by minimizing b/(1−P) before the mapping technique is employed. The equation b/(1−P) may be written as follows:

$$\frac{b}{1 - \frac{{2}^{b} - B ⌊ \frac{{2}^{b}}{B} ⌋}{{2}^{b}}} = \frac{b}{1 - \frac{{2}^{b} mod B}{{2}^{b}}}$$

It is sufficient to check for b between ld B and 2 ld B, or in other words, B≦.2^{b}≦B². As can be seen (2^{b} mod B)/2^{b} is always smaller than B/2^{b}, and will rapidly decrease as b decreases. Thus, the equation b/(1−P) will first decrease but then will quickly increase with b, i.e., if b is twice as large as ld B then the equation will be in the increasing part. Hence, optimal values for b may be found easily by simple trial and error by starting with ld B then considering a small number of trial values resulting from changes to b. Typically, this optional step would precede the others steps described above, particularly if pseudo-random bits are expensive to generate.

In this implementation, where there is a 32-bit input (i.e., b is 32), the optional step may not be necessary given that the size of the desired output range generally is expected to be well below 2³² and the PRNG generates unsigned long integer numbers.

The discarded PRNs generated by the PRNG (i.e., those generated PRNs that are greater than L) can be re-used for creating a PRN stream in the range 0, . . . R−L. The discarded numbers could be collected and then mapped into the range min, . . . max as well. Collecting and mapping in this manner may be beneficial if arithmetic costs are much lower than the computational generation costs for the PRNs.

One of the numeric data types that ABAP supports is packed integers. Packed integers can be 1 to 16 bytes long, with two decimal digits packed into each byte, and one decimal digit and the sign packed into the last byte. Thus, packed numbers may include up to 31 decimal digits with a range (1-10³¹), . . . (10³¹-1) and typically are used in calculations of sizes, lengths, weights and sums of money. Generally, four 32-bit numbers are needed to produce uniformly distributed random numbers in this range. Unfortunately, a direct implementation generally would require arithmetic beyond the range of packed integers, which typically is avoided because the cost of implementing and testing such arithmetic is usually considered not worth the theoretical performance gains. Besides, pseudo-random integers generally are preferred for all performance critical issues. Thus, a technique to generate packed numbers using a PRNG, in addition to methodology to map packed numbers to a desired output range, is described below. This technique also could be used any time it is desirable to map PRNs to a range that is larger than the range in which they were generated.

FIG. 5 illustrates, in general, a technique for generating and mapping packed numbers to a desired output range. As stated above, a b-bit PRNG typically can generate 2^{b}-1 uniformly distributed PRNs. PRNG 500 is a PRNG that does not provide PRNs within a specified output range. In one implementation, PRNG 500 is a 32-bit PRN, which has a period of 2³²−1. An Algorithm 504, e.g., a generation function, obtains these uniformly distributed PRNs to generate Packed Numbers 505, which are used by Algorithm 506, e.g., a mapping function, to map selected Packed Numbers 505 to a Desired Output Range 510 (i.e., min, . . . max) of size B, such that the mapped numbers are uniformly distributed across the Desired Output Range 510. The Algorithms 504, 506 can be implemented in ABAP and/or other programming languages.

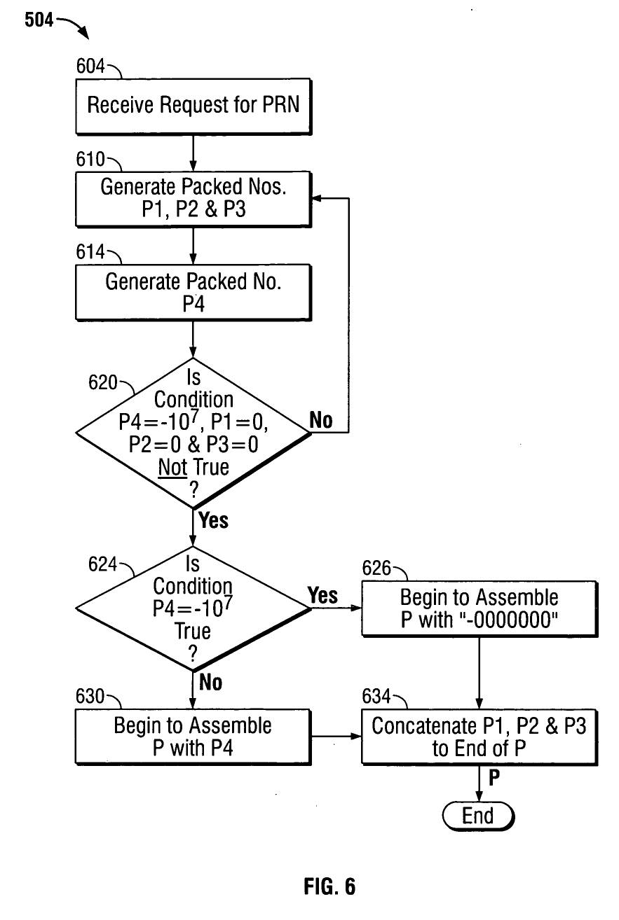

FIG. 6 illustrates a process that may be executed in Algorithm 504 to generate packed numbers using PRNG 500. In step 604, Algorithm 504 receives a request for one ore more pseudo-random packed numbers. Next, in step 610, the process described above with reference to FIG. 4 is implemented to generate three 8-digit unsigned component packed numbers P1, P2, and P3 that are in the range 0, . . . 10⁸−1. On average 1.0226 integer PRNs need to be generated for each packed number P1, P2 and P3, i.e., a total of 3.0678 integer PRNs. In step 614, the process described above with reference to FIG. 4 is again implemented to generate a signed component packed number P4 in the range—10⁷, . . . 10⁷-1. On average 1.0035 integer PRNs need to be generated to obtain P4. Thus, on average 4.0714 PRNs need to be generated, which is less than 2% overhead. In step 620, a test is performed to determine whether the following condition is satisfied: P4=−10⁷ and P1=0 and P2=0 and P3=0. Steps 610 and 614 are repeated until this condition is not true. Also in step 620, P1, P2, P3 and P4 may be discarded in order to achieve a uniform output distribution. However, this event will occur in about 1 in 2*10³¹ times, which is negligible. In step 624, if the condition P4=−10⁷ is true, step 626 is performed in which the first eight places of the output packed number P are “−0000000” and returned. Otherwise, step 630 is performed in which the first eight places of the output packed number P are P4, including the sign. In either step 624 or 630, the output number P will be filled with a sign and 7 digits. Next, in step 634, component packed numbers P1, P2, and P3 are concatenated to the end of the output number P in that order. Thus, at this point, the output number P has a total of one sign and 31 digits. Moreover, the steps just described produce a uniform distribution of packed numbers if the input numbers are uniformly distributed.

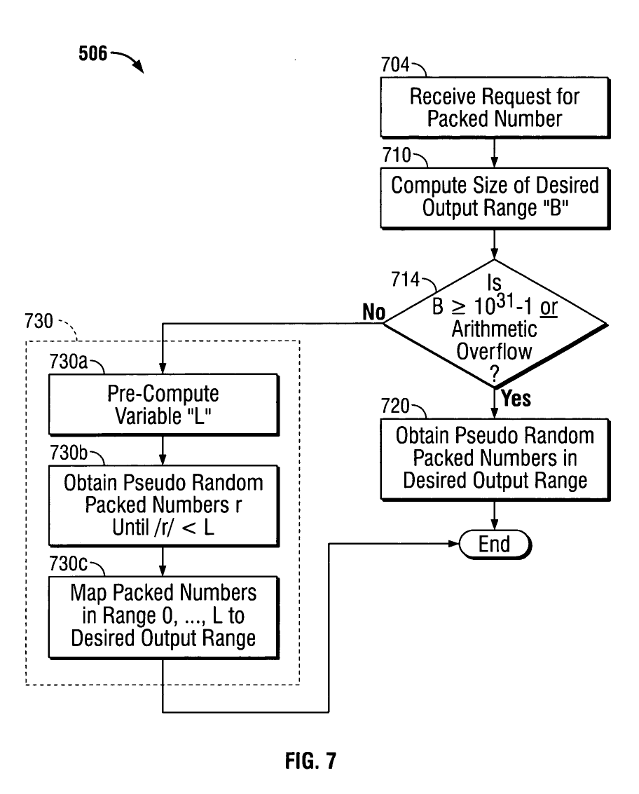

FIG. 7 depicts a process that may be executed in Algorithm 506 to map selected packed numbers out of the packed numbers P generated by Algorithm 504 to the Desired Output Range 510 according to one implementation, e.g., a database application programmed using the Advanced Business Application Programming (“ABAP”) language. In step 704, Algorithm 506 receives a request for one ore more pseudo-random packed numbers in the Desired Output Range 510. Next, in step 710, the size of the Desired Output Range 510, B, is computed as follows:
B=max−min+1

Next in step 714, a test is performed to determine whether either of the following conditions exists: B≧10³¹−1 or arithmetic overflow resulting from step 710. If either of these conditions exists, then direct mapping is required and the process continues to step 720. Otherwise, the process continues to step 730. In step 720, pseudo-random packed numbers are obtained from Algorithm 504 until a packed number is in the Desired Output Range 510, i.e., in the range min, . . . max. The packed number is returned in response to the request for a pseudo-random packed number in the Desired Output Range 510 and the process ends.

In step 730, a mapping function is executed. In step 730a, the mapping function performs arithmetic computations as follows: L=S*B, where S=(10³¹ div B). The variable L is an optimal match to the desired output range. Next, in step 730b, the mapping function obtains uniformly distributed pseudo-random packed numbers r generated by Algorithm 704 until |r|<L. In step 730c, the mapping function maps those packed numbers having absolute values that fall within the range 0, 1, . . . L to the same number of numbers in or the Desired Output Range 510, which are (|r|div S)+min. As a result, the packed numbers in the Desired Output Range 510 are uniformly distributed pseudo-random packed numbers. Optionally, the objective of steps 730b and 730c could be achieved by causing the Algorithm 504 to generate uniformly distributed pseudo-random packed numbers r until |r|<L.

The direct mapping scenario (step 720) represents a worst case for the above process. In the direct mapping scenario, up to 50% of the intermediate numbers will be discarded. Thus, the worst case cost for generating one mapped packed number is generating 8.15 unsigned integer pseudo-random numbers. However, it is expected that the typical desired output range is much smaller than 10³¹. Hence, the typical cost is generally closer to 4.1 unsigned integer PRNs.

The following code module, written in ABAP (although any other language suitable to generate and map packed numbers could be used), generally is suitable to generate and map pseudo-random packet numbers to a desired output range:

```
METHODS packedinrange
IMPORTING
  min TYPE p31_0
  max TYPE p31_0
RETURNING
  VALUE(value) TYPE p31_0.
CONSTANTS max_packed TYPE p31_0 VALUE
```

‘9999999999999999999999999999999’.

| | |
|---|---|
| DATA raw_pseudo_random_number | TYPE p31_0. |

| | |
|---|---|
| DATA range | TYPE p31_0. |
| DATA bin_size | TYPE p31_0. |

| | |
|---|---|
| DATA collective_bin_size | TYPE p31_0. |

| | |
|---|---|
| DATA direct_mapping_required | TYPE abap_bool |
| | VALUE false. |

```
IF min > max.
  RAISE EXCEPTION TYPE cx_abap_random.
ENDIF.
TRY.
  range = max − min + 1.
    IF range >= max_packed.
    direct_mapping_required = true.
    ENDIF.
  CATCH cx_sy_arithmetic_overflow.
    direct_mapping_required = true.
  ENDTRY.
  IF direct_mapping_required = false.
  bin_size = max_packed DIV range.
  collective_bin_size = bin_size * range.
  ENDIF.
  IF direct_mapping_required = true.
  DO.
    raw_pseudo_random_number = me->packed( ).
    IF raw_pseudo_random_number <= max AND
    raw_pseudo_random_number >= min.
    value = raw_pseudo_random_number.
    RETURN.
    ENDIF.
  ENDDO.
  ELSE.
  DO.
    raw_pseudo_random_number = me->packed( ).
    IF raw_pseudo_random_number < 0.
    raw_pseudo_random_number =
    − raw_pseudo_random_number.
    ELSEIF raw_pseudo_random_number = 0.
    CONTINUE.
    ENDIF.
    IF raw_pseudo_random_number > collective_bin_size.
    CONTINUE.
    ELSE.
    EXIT.
    ENDIF.
  ENDDO.
  value = ( raw_pseudo_random_number − 1 )
  DIV bin_size + min.
  RETURN.
  ENDIF.
ENDMETHOD.
```

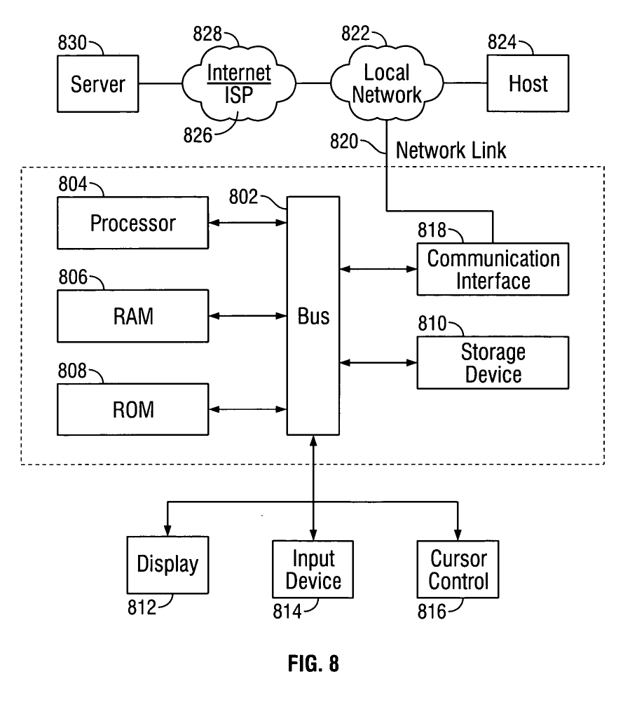

FIG. 8 is a block diagram that illustrates a computer system 800, such as a programmable data processing system, in which the objected oriented interface for generating PRNs within a specified output range described herein may be implemented. Computer system 800 includes a bus 802 or other communication mechanism for communicating information, and a processor 804 coupled with bus 802 for processing information. Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), liquid crystal display (LCD), or plasma television, for displaying information to a computer user. An input device 814, including alphanumeric and other keys, is coupled to bus 802 for communicating information and command selections to processor 804. Another type of user input device is cursor control 816, such as a mouse, a trackball, key switch, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

The PRNG interface techniques are used with computer system 800. According to one embodiment, PRNs are generated within a specified output range by computer system 800 in response to processor 804 executing one or more sequences of one or more instructions contained in main memory 806. Such instructions may be read into main memory 806 from another computer-readable medium, such as storage device 810. Execution of the sequences of instructions contained in main memory 806 causes processor 804 to perform the processes described herein. In alternative embodiments, hard-wired circuitry may be used in place of or in combination with software instructions to implement the PRNG interface techniques. Thus, embodiments described herein are not limited to any specific combination of hardware circuitry and software.

The term “computer-readable medium” as used herein refers to any medium that participates in providing instructions to processor 804 for execution. Such a medium may take many forms, including but not limited to, non-volatile media, volatile media, and transmission media. Non-volatile media includes, for example, optical or magnetic disks, such as storage device 810. Volatile media includes dynamic memory, such as main memory 806. Transmission media includes coaxial cables, copper wire and fiber optics, including the wires that comprise bus 802. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, DVD, or any other optical medium, punch cards, paper tape, or any other physical medium with patterns of holes, a RAM, a PROM, and EPROM, a FLASH-EPROM, or any other memory chip or cartridge, a carrier wave as described hereinafter, or any other medium from which a computer can read.

Various forms of computer-readable media may be involved in carrying one or more sequences of one or more instructions to processor 804 for execution. For example, the instructions may initially be carried on a magnetic disk of a remote computer. The remote computer can load the instructions into its dynamic memory and send the instructions over a telephone line using a modem. A modern local to computer system 800 can receive the data on the telephone line and use an infrared transmitter to convert the data to an infrared signal. An infrared detector coupled to bus 802 can receive the data carried in the infrared signal and place the data on bus 802. Bus 802 carries the data to main memory 806, from which processor 804 retrieves and executes the instructions. The instructions received by main memory 806 may optionally be stored on storage device 810 either before or after execution by processor 804. Any of the computer-readable media may be used to store and/or transmit one or more serialized PRNG objects.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, a broadband integrated services digital network (B-ISDN), a modem to provide a data communication connection to a corresponding type of telephone line or any other communication interface known to one of ordinary skill. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the worldwide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are exemplary forms of carrier waves transporting the information.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818. In one aspect, one such downloaded application provides for PRN generation as described herein.

Processor 804 may execute the received code as it is received, and/or stored in storage device 810, or other non-volatile storage for later execution. In this manner, computer system 800 may obtain application code in the form of a carrier wave. Processor 804 may execute compiled code and data through a mechanism, such as a virtual machine, which translates compiled code from an intermediate format, such as byte code, to machine code executable by processor 804.

Alternative implementations of the systems and techniques disclosed are also possible. The PRNG interface described may be implemented in any object-oriented programming language using the mechanisms and techniques native to the language.

An alternative implementation of a PRNG class may be defined using different programming mechanisms and techniques. For example, although the methods and variables of the PRNG interface may be both defined and implemented in single PRNG class, the PRNG interface may be defined in one class, and implemented in one or more other classes using programming mechanisms and techniques, including polymorphism, which may include constructs such as abstract classes, interfaces, inheritance, etc. For example, a PRNG interface may be defined in an abstract class including method stubs that define the input and output variables, and their types. A second class may implement the abstract class by implementing the method stubs. In addition, alternative implementations of the PRNG class may define a PRNG object with more or fewer class members, may have different names for the class members, and may have different types of input or output. For example, a PRNG class may be defined to merely include a method such as create 105, a method such as get_next 110, and a variable such as stream_Pointer 130.

Although a few alternative implementations have been described in detail above, other modifications are possible. Other implementations may be within the scope of the following claims. For example, the operations described can be performed in a different order, or using different sub-processes, and still achieve desirable results.

1. A method of facilitating the generation of pseudo-random numbers, the method comprising:
receiving input specifying an output range; and
invoking a constructor method to generate a pseudo-random number generator object having one or more methods for generating pseudo-random numbers within the specified output range.

2. The method of claim 1, wherein the generated pseudo-random number generator object is configured to generate pseudo-random numbers that are uniformly distributed across the specified output range.

3. The method of claim 1, further comprising:
invoking a method within the pseudo-random number generator object for outputting a pseudo-random number within the specified output range.

4. The method of claim 1, further comprising:
receiving input specifying a seed to be used by the pseudo-random number generator object to generate pseudo-random numbers.

5. The method of claim 4, wherein a sequence of pseudo-random numbers generated within the specified output range is reproducible if the input specifies the same seed.

6. The method of claim 1, further comprising:
invoking a method within the generated pseudo-random number generator object for generating a seed.

7. The method of claim 1, wherein a method for generating pseudo-random numbers uniformly distributed across the specified output range comprises:
generating a plurality of pseudo-random numbers having a uniform distribution in a source range,
selecting an optimal subset of the plurality of pseudo-random numbers to map, and
mapping the selected pseudo-random numbers to a corresponding number in the specified output range such that the mapped numbers are uniformly distributed across the specified output range.

8. The method of claim 1, wherein the pseudo-random number generator object is serializable.

9. The method of claim 1, wherein the constructor method comprises:
generating a plurality of pseudo-random numbers having a uniform distribution in a source range,
selecting an optimal subset of the plurality of pseudo-random numbers to map, and
mapping the selected pseudo-random numbers to a corresponding number in the specified output range such that the mapped numbers are uniformly distributed across the specified output range.

10. A method of facilitating the generation of a pseudo-random number generator, the method comprising:
providing a class definition that defines an object for generating pseudo-random numbers within a specified output range;
receiving input specifying the output range; and
invoking a constructor method to create a pseudo-random number generator object capable of providing pseudo-random numbers in the specified output range.

11. The method of claim 10, further comprising:
receiving an instruction to return a pseudo-random number within the specified output range; and
returning a next pseudo-random number within the specified output range.

12. An object class definition comprising:
a constructor method for generating a pseudo-random number generator object that is capable of generating pseudo-random numbers within a specified output range; and
a method for instructing the pseudo-random number generator object to output a pseudo-random numbers within the specified output range.

13. The object class definition of claim 12, wherein the pseudo-random number generator outputs numbers of a single data type.

14. The object class definition of claim 12, wherein the pseudo-random number generator object is serializable.

15. The object class definition of claim 12, wherein generating pseudo-random numbers within a specified output range includes using a specified seed.

16. The object class definition of claim 15, wherein generating pseudo-random numbers within a specified output range generates a reproducible sequence of pseudo-random numbers if the same seed is used.

17. A method of generating pseudo-random numbers, the method comprising:
providing an output range to a pseudo-random number generator object; and
invoking a method within the pseudo-random number generator object that causes pseudo-random numbers within the output range to be generated by the pseudo-random number generator object.

18. The method of claim 17, further comprising:
invoking a method to generate a pseudo-random number generator object that can generate pseudo-random numbers within a specified output range.

19. The method of claim 17, further comprising:
providing a seed to a pseudo-random number generator object.

20. The method of claim 19, wherein the seed is predefined.

21. The method of claim 17, wherein the output range is predefined.

22. A method of facilitating generation of PRNs, the method comprising:
providing a single object-oriented interface that enables PRN generation and PRN mapping, the single object-oriented interface comprising a constructor method for generating a PRNG object that is capable of generating PRNs within a specified output range and a method for instructing the PRNG object to output PRNs within the specified output range.
